(19) United States
(12) Patent Application Publication
(10) Pub. No.: US 2005/0028957 A1
(43) Pub. Date: Feb. 10, 2005

(54) Method and device for measuring of solid matter particles in pulp suspension

(75) Inventor: Heikki Suistomaa, Joroinen (FI)

Correspondence Address: HARRINGTON & SMITH, LLP, 4 RESEARCH DRIVE, SHELTON, CT, 06484-6212, US

(73) Assignee: Metso Automation Oy

(21) Appl. No.: 10/402,496

(22) Filed: Mar. 28, 2003

Related U.S. Application Data
(63) Continuation of application No. PCT/FI01/00851, filed on Sep. 28, 2001.

(30) Foreign Application Priority Data
Sep. 28, 2000 (FI) 20002128

(51) Int. Cl. G01N 21/85; G01N 15/06

(52) U.S. Cl. 162/198; 73/61.71; 162/263

(57) ABSTRACT

The subject of the invention is a method and a device for measuring of solid matter particles of pulp suspension, in which method a sample of pulp suspension is separated and scanned and the amount and the quality of solids are examined from the picture. According to the method the sample separated from a pulp suspension with know consistency of dry substances is fed at known feeding speed onto the wire, which is an endless loop and moves at know speed, and where water is removed with a drying device from the sample, and which transports the sample mainly as a constant matt to a camera device, where the sample is scanned and on the basis of this picture and information about the feeding speed of the sample, moving speed of the wire and the consistency information the absolute and/or relative amount and quality of solids are measured.

The subject of the invention is a method for automatically measuring solid matter particles of pulp suspension in which a sample of pulp suspension is taken and scanned and the amount and quality of solids are examined from the picture. Furthermore, the subject of the invention is a device to apply the method including a frame, a reservoir for the sample, a sample feeding unit, a camera device to scan the sample and an imaging device to measuring the amount and the quality of solids.

It is of great importance to follow-up the solid impurities, for example, in process waters and pulp suspensions in the wood processing industry. Foreign particles may cause disturbance in the course of the process and have influence on the quality of the final product. For the time being, the amount and quality of refuse have been able to be visually controlled either in the pulp suspension itself or in the rejection flow of filters. However, the final product e.g. paper or laboratory sheet are mainly been controlled and there refuse can be detected as single particles or spots of dirt.

The main disadvantage of the latter method used so often is the fact that impurities are been detected only in the end of the process, though their source exists in the early phase, for example, in the production of pulp. Furthermore, as a result of disturbing materials in process there may occur a reaction that is changing colour, which complicates the perceiving of impurities in the final product and makes the definition more dependent on an individual.

There are methods and equipments, which help to measuring properties of pulp pulp. These methods and equipments are rather complicated and they do not offer results continuously and reliably.

The purpose of the invention is to provide a method and a device with which the earlier mentioned problems are prevented. Furthermore, the purpose of the invention is to provide a method and a device utilizing of which the definition of impurities may be carried out near the source of the problem instead of examining the highly processed final product. Furthermore, the purpose of the invention is to provide a method and a device, which are automatized, simple and reliable, and by using which subjective mistakes that always occur when using visual definition are prevented.

The purpose of the invention is achieved by a method and a device, which possess the characteristics presented in the appended claims.

In the method according to the invention a sample of pulp suspension with known consistency of dry substances is fed at known input speed onto a movable wire moving at known speed and functioning as a transporting mechanism and constructed to be an endless loop, water is removed from the sample on this wire with a drying device and the sample is transported continuously to the sphere of a camera where the sample is scanned and on the basis of this image the amount and the quality of solids of the sample are measured. The image is analyzed with a known image analysis device automatically and the whole process according to the method is automatic. A wire or a mechanism equivalent to it is a very suitable transport to this purpose and an endless loop is a simple, advantageous and reliable construction solution. The input speed and transporting speed are constants or they are known/regulated/controlled such that the speed is known.

The method is completely automatic and therefore the results are reliable and do not depend on human uncertainty and errors. Furthermore, the device can function independently for long periods of time. The method allows to measuring solids, impurities, for example, in pulp suspension immediately after it has been produced, so the results are available at that moment. A troublesome and monotonous stage made by hand can be quickly completed by using automation. Compared with the commonly used definition of the final product intermediate processes may be passed and the accuracy of the method gets remarkable better and problems are noticed earlier so they do not proceed to the final product.

In the advantageous application of the invention the amount of the sample fed onto the wire is measured in respect with the area of the wire by measuring the amount of unfed sample in respect with total mass or volume before starting to feed the sample and after a certain time when feeding has started by calculating the difference of these measurements and proportion this difference to the area of wire passing the feeding device in the same time period and calculated from the speed of the wire and known width of the wire. The amount of the scanned and analyzed sample must be known in order to be able to inform the amount of measured solids as ratio of the amounts of solids and sample, that is as percentage besides the absolute amount. Measured amount of solids may be proportioned by qualification classes to the amount of analyzed sample, which is necessary when utilizing the results of the measurements, by adding automatically to the scanned information the information known or measured during the treatment of the sample about the amount of the sample to be dosed onto the wire in respect with the area of the wire.

In the advantageous application of the invention the pulp suspension sample in the head box is fed through a feeding opening the height of which is regulated with a regulating device to a transporting device by its own hydrostatic pressure. Thus may the thickness of the sample be regulated as needed.

In the next advantageous additional application of the invention water is removed from the sample by negative pressure in a drying device. With negative pressure it is possible to accomplish efficient drying.

In the next application the sample is scanned after drying with a camera against a light from a light fixture placed in the opposite side of the transporting device. With a light source placed like this the camera is provided with a good light.

In the device according to the invention there is a feeding unit for the sample the feeding speed of which may be regulated, a transporting device for the sample e.g. an endless wire, supported to the frame movable and a drying device to remove water from the sample on the transporting device. The device is fully automatic, therefore the results are reliable and not dependent on human uncertainties and errors. Furthermore, the device can function independently for long periods of time when necessary.

In advantageous application of the invention as a reservoir device functions a head box where the pulp suspension is moved to. Thus it is possible to measure solids, for example, impurities, refuse etc. in the pulp suspension immediately after it has been produced.

In spite of the starting point e.g. the definition of the amount and quality of refuse, sphere of application of the invention is not wished to be unnecessary limited. The method is also suitable, for example, to analyze main, wanted particles of pulp suspension. Other applications may be possible with modifications within the limits of claims of patent.

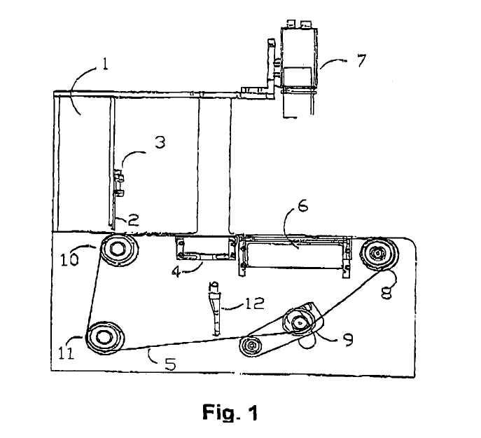

In the following, the invention is defined in more detail with reference to FIG. 1, in which one application of the device according to the invention is demonstrated viewed from the side.

In the device according to figure there is a frame, reservoir 1 for the sample, which is a head box and where the amount of the sample to be fed may be regulated, a wire 5 functioning as a transporting device under it to transport the sample, a drying device 4 functioning by negative pressure to remove moist from the sample on the wire, a camera device 7, placed at a distant from the wire to scan the sample and a light fixture 6 to light the sample placed on the opposite side of the camera device. Furthermore, there is an image analysis device in the device to measuring the amount and quality of solids and known measuring equipment or equivalent to measure the amount of the sample in various points as well as measuring equipment to measure the speed of the wire and the feeding speed of the sample, which are not demonstrated in the figure. The wire has the shape of an endless loop and it is driven with the help of a driving roller 8 and other rollers 9,10 and 11.

The device functions as follows: a certain amount of sample, diluted to a certain consistency is brought either manually or automatically to the head box 1. The sample flows down because of its own hydrostatic pressure through the feeding opening in the lower part of the head box onto the wire 5 mainly as a constant matt at known speed. The height of the feeding opening can be regulated by moving the upper edge 2 of the opening with a regulating device 3. The pressure is kept constant with an overflow pipe. The wire moves as an endless loop supported by driving roller 8 and other rollers 9, 10 and 11 to marked direction transporting the sample with it. The feeding speed of the sample to the wire is controlled by measuring the amount of the sample in the head box at certain intervals. The sample then proceeds onto the suction box where it is dried by negative pressure. After drying the sample enters the measuring point. The sample lightened by the light fixture 6 under the wire is scanned by a video camera 7. Solids are measured on the basis of the camera picture with an automatic imaging programme or by other means. By calculating the amount of the sample on the area of the picture on the basis of the feeding speed of the sample and moving speed and width of the wire one gets the amount of solids as a figure of concentration of original sample as demonstrated earlier. The quality of solid may also be determined by analyzing the picture.

After definition the sample is removed from the wire with a liquid or gas spray realized with a jet 12 on the opposite side; in the model developed at the moment compressed air is used, but other solutions are possible as well. In case another definition is wished to be accomplished in order to have more accurate result the same sample may be circulated constantly through earlier mentioned phases.

The invention is not limited to application shown but may vary within the idea of the invention within the limits set fort the claims.

1. Method for measuring particles of solid matter particles in pulp suspension, in which method
a sample is separated from a pulp suspension,
a sample of pulp suspension with known consistency of dry substances is fed at known input speed onto a movable wire moving at known speed,
which movable wire is constructed to be an endless loop,
water is removed on this wire with a drying device,
the sample is transported by the wire mainly as a continuous matt to a camera device,
the sample is scanned by the camera device, and
the absolute and/or relative amount and quality of solids are measured on the basis of the picture and information on the feeding speed of the sample and the moving speed of the wire and consistency information

2. Method according to claim 1, in which method
the amount of the sample fed onto the wire is measured in respect with the area of the wire by measuring the amount of the taken sample in respect with the pulp or the volume before starting to feed the sample,
and after some time the feeding has started by counting the difference of these measurements and by proportion this difference to the area of wire passing the feeding device in the same time period,
and calculated from the speed of the wire and known width of the wire.

3. Method according to claim 1, in which method
the pulp suspension sample in a head box is fed to the transporting device by its own hydrostatic pressure through the feeding opening in the head box,
and the height of the opening is regulated with a regulating device.

4. Method according to claim 1, in which method
the sample is dried in the drying device with negative pressure.

5. Method according to claim 4, in which method
after drying the sample is scanned with a camera device against a light realized with a light fixture placed on the opposite side of the transporting device.

6. Device to apply the method according to claim 1, into which device belong
a frame,
a reservoir for the sample,
a feeding unit for the sample, feeding speed of which is controlled,
a camera device to scan the sample and an imaging device to measure the amount and the quality of solids,
a transporting device for the sample, which transporting device is an endless wire supported to the frame movable, and
a drying device to remove water from the sample on the transporting device.

7. Device according to claim 6, in which device
a reservoir for the sample is a head box.

8. Device according to claim 6, in which device
the endless wire has been supported to the frame movable on rollers.

9. Device according to claim 6, in which device
as a drying device there is a drying device functioning by negative pressure placed on the other side of the wire.

10. Device according to claim 8, in which device
there is a light fixture placed on the opposite side of the wire at the camera device.
